(19) United States
(12) Patent Application Publication
(10) Pub. No.: US 2005/0039675 A1
(43) Pub. Date: Feb. 24, 2005

(54) Spin coating apparatus and coated substrate manufactured using the same

(76) Inventors: Tae Sik Kang, Daejeon-city (KR); Mi Young Han, Daejeon-city (KR); Seongkeun Lee, Daejeon-city (KR); Sung Hoon Jang, Daejeon-city (KR); Youngjun Hong, Daejeon-city (KR)

Correspondence Address: BIRCH STEWART KOLASCH & BIRCH, PO BOX 747, FALLS CHURCH, VA, 22040-0747, US

(21) Appl. No.: 10/921,145

(22) Filed: Aug. 19, 2004

(30) Foreign Application Priority Data
Aug. 22, 2003 (KR) 2003-58133
Aug. 18, 2004 (KR) 2004-65148

(51) Int. Cl. B05C 11/02; B05C 13/00

(52) U.S. Cl. 118/52

(57) ABSTRACT

A spin coating apparatus is provided. The spin coating apparatus includes a ring-shaped or polygonal member. An upper portion of the ring-shaped or polygonal member has an inclined portion extending downward and outward, and an inner portion of the inclined portion is adjacent to or in contact with an outer edge of a substrate. An inner side surface of the ring-shaped or polygonal member is inclined downward and outward. When a surface of the substrate is coated with a coating solution using the spin coating apparatus, a ski-jump phenomenon occurring at an outer edge of the substrate can be reduced and contamination of the substrate due to the coating solution can be prevented.

### BACKGROUND OF THE INVENTION

This application claims the priorities of Korean Patent Application No. 2003-0058133, filed on Aug. 22, 2003, and Korean Patent Application No. 2004-0065148, filed on Aug. 18, 2004, in the Korean Intellectual Property Office, the disclosures of which are incorporated herein in its entirety by reference.

1. Field of the Invention

The present invention relates to a spin coating apparatus, and more particularly, to a spin coating apparatus capable of reducing ski-jump phenomenon (also referred to as a bump, a convex portion, an upheaval, a protrusion, a bead, and so on) occurring at an outer edge of a substrate when spin-coating with a ring-shaped or polygonal member and a coated substrate manufactured using the same.

2. Description of the Related Art

FIG. 1 is a side view of coating solution spin-coated on a substrate using a conventional method. In said method a liquid coating solution is dropped on the central portion of a substrate that is rotating at a low speed. Then, the substrate is rotated at a high speed. The coating solution is spread outward from the center of the substrate due to the centrifugal force, through coating the entire substrate. However, when a high-viscosity coating solution is coated on the substrate in the conventional spin coating method, the coating solution becomes conglomerated at end portions 20a of the substrate due to viscoelasticity and surface tension of the coating solution. If the conglomerated coating solution is hardened in such a state, a ski-jump composed of a hill is formed. Due to the ski-jump, the entire substrate cannot be uniformly coated.

As the viscosity of the coating solution is increased, the ski-jump becomes worse. In manufacturing an optical disc, a semiconductor substrate, an ultrasonic transducer, and so on, a high-viscosity coating solution is spin-coated on a substrate. At this time, a uniform coating layer cannot be obtained due to a formation of ski-jump. Although the problem of the ski-jump is described in connection with selected conventional applications, the present invention is not limited to these applications. That is, the present invention can be applied to any fields in which the problem of the ski-jump occurs when spin coating.

Optical discs are widely used as data recording media read by an optical pick-up which records/reproduces data in a non-contact manner. Conventional discs include 600-800 MB compact discs (CD) and 4-10 GB digital versatile discs (DVD), and optical discs with increased data density are being developed. Recently, 20 GB or larger Blu-ray discs (BD) using blue laser for loading and recording have been developed to store high picture quality and tone quality multimedia. According to the System Description Blu-ray Disc Rewritable Format, a lead-out area where information on the substrate is stored is defined with a radius of up to 58.5 mm. Therefore, the data recording area must secure a minimum radius of 58.5 mm, that is, a diameter of 117 mm. In the case of a 100 μm cover layer, the thickness of the cover layer, it must be within ±2 μm over the radius of 58.5 mm. In the remaining 1.5 mm peripheral area, the ski-jump must be less than 10 μm in height. When an UV(ultraviolet) curable resin layer is coated on the optical disc using the conventional spin coating method, the ski-jump is formed to a height of more than about 45 μm in a 100 μm resin layer. Thus, such an optical disc does not satisfy the above-mentioned specification. In order to solve the ski-jump problem, Korean Patent Laid-Open Publication No. 2003-4541 discloses a method which includes: preparing a substrate with a larger diameter than an optical disc to be finally completed; forming a cover layer having a predetermined thickness by dropping an UV curable resin on the substrate; irradiating UV rays on a bump lifted upwards at a periphery of the cover layer so as to harden the bump; and cutting the bump. However, since this method includes additionally the cutting operation in the manufacturing process of the optical disc, manufacturing costs are increased and it takes a long time to manufacture the optical disc. The manufacturing efficiency is degraded and the substrate may be broken, cracked and bent in the operation of cutting the bump. In Korean Patent Laid-Open Publication No. 2001-55044, an optical disc has an inner diameter equal to an outside diameter of a substrate and an optical disc housing (30, in FIG. 2) has a groove whose depth is equal to a thickness of the optical disc. The optical disc is mounted on the optical disc housing and an UV curable resin is spin-coated on the optical disk. In this case, however, it is difficult to extract the optical disc from the housing after the spin coating. Also, the resin flows into a gap between the substrate and the housing, thereby contaminating a rear side of the optical disc. In the repetitive coatings, the coating solution stays inside a jig and is not drained, causing serious contamination of the optical disc. Although the size of the ski-jump is reduced compared to conventional spin coating methods, it is still difficult to obtain a uniform resin layer up to a radius of 58.5 mm, and the ski-jump is about 20 μm.

When forming integrated circuits on a semiconductor wafer, photolithography is widely used. In photolithography, a photoresist film is used to obtain elements by implanting impurities into a predefined area on the semiconductor wafer or by forming a thin film layer in the predefined area. The photolithography includes an operation of thinly coating a photoresist layer on the semiconductor wafer, an operation of exposing and developing the coated photoresist layer using a mask, an operation of implanting impurities through an opening of the photoresist layer, and an operation of removing the photoresist layer after forming the thin film layer. A spin coating method is widely used. According to the spin coating method, a small amount of photoresist is coated on the center of the semiconductor wafer, and the semiconductor wafer is rotated to spread the coated photoresist to a constant thickness on the upper surface of the semiconductor wafer. In the operation of implanting the impurities or forming the thin film layer, it is difficult to thickly form the photoresist layer to a thickness of tens of μm. This is because the photoresist has a predetermined viscosity that causes the photoresist layer to thickly form at an edge of the semiconductor wafer during the spin coating. When a 60 μm photoresist layer is spin-coated on the semiconductor wafer, a ski-jump is formed within 7 mm width and a 120 μm thickness at an edge of the semiconductor wafer. In order to solve this problem, Korean Patent Laid-Open Publication No. 2001-0017145 discloses a method including: performing a coating and soft hardening process to form a first photoresist layer on a semiconductor wafer to a thickness corresponding to about 50% of the thickness of a photoresist layer to be formed; removing an edge bead (ski-jump) of the first photoresist layer formed at an edge using a thinner; and performing a coating and soft hardening process to form a second photoresist layer to the remaining 50% of the thickness of the photoresist layer to be formed. Since in this method, each of the coating process and the hardening must be performed twice, the manufacturing process is complicated and it takes a long time to manufacture the photoresist layer. Also, wastewater is generated due to the thinner used to remove the edge bead of the first photoresist layer, thus increasing manufacturing costs for processing the wastewater.

A variety of integrated circuits are used in electronic equipments such as computers. As the integrated circuits become scaled-down and attain high performance, manufacturing reliability with high precision and high performance is required. In order to increase the degree of integration of the integrated circuits, a multi-layer interconnection circuit shown in FIG. 3 is used. Referring to FIG. 3, a first insulating layer 32 and an oxide layer are formed on a silicon substrate 31, and a first interconnection layer 33 formed of aluminum or the like is formed on the first insulating layer. An interlayer insulating layer 34 formed of silica or silicon nitride layer is formed by chemical vapor deposition (CVD) or plasma CVD. A silica insulating layer (a planarization layer) 35 is formed on the interlayer insulating layer 34 to planarize the interlayer insulating layer 34. If necessary, a second insulating layer 36 is formed on the silica insulating layer. Also, an interconnection layer, an interlayer insulating layer, a planarization layer and an insulating layer may be formed on the second insulating layer 36. The method of forming the interlayer insulating layer may include forming SiO₂ on a substrate by CVD using a gas such as SiH₄, forming SiO₂ by plasma-depositing tetraethoxysilane (TEOS), or forming SiO₂ by coating a coating solution for a silane-based insulating layer on a substrate by spin coating. The third method has a great processing capability and can be used to form a planar layer. However, when the coating solution is spin-coated, a convex portion (ski-jump) is formed at the periphery of the silicon wafer, as shown in FIG. 1. The periphery of the silicon wafer comes into contact with other elements, causing a crack. When the crack occurs, a large amount of foreign material occurs, thus reducing productivity. In order to solve this problem, Japanese Patent NO. 8-316186 discloses a method of cleaning and removing the convex portion formed around the silicon wafer by discharging a solvent onto the convex portion after the spin coating. In this case, the cleaning solvent is different depends on the kind of coating solution used for the insulating layer. For example, the cleaning solvent depends on the kinds, concentration and solvent of the insulating component. An additional bump (protrusion) may be formed during the cleaning and removing operation. This bump is a cause of foreign material such as the convex portion.

An ultrasonic endoscope scans an oscillating ultrasonic beam generated by an ultrasonic transducer along a predetermined path, and receives an ultrasonic wave reflected from an internal wall of an internal organ or a lesion portion through the ultrasonic transducer. By processing the received information, an ultrasonic tomogram is produced. The ultrasonic transducer is generally composed of piezoelectric ceramics. Due to a great difference between the piezoelectric ceramics and a bio sound impedance, reflection and loss of the ultrasonic wave occur at their interface. In order to absorb the difference and reduce sound loss, a acoustic matching layer formed of a resin material or the like is installed in a sound radiation side. An oscillation frequency of the ultrasonic transducer is on the order of several MHz to tens of MHz. Therefore, the acoustic matching layer having a thickness equal to ¼ of the ultrasonic wavelength is tens of μm thick in order to obtain a speed of sound of 2500-3000 m/s within the resin. When the acoustic matching layer is formed by the spin coating method, the viscosity of the resin must be very high, such that a thickness unstable portion (ski-jump) occurs at the edge of the acoustic matching layer. In order to solve this problem, Japanese Patent No. 5-103396 discloses a method of manufacturing a acoustic matching layer, including: dropping an UV curable resin on a substrate; diffusing the UV curable resin by rotating the substrate; irradiating UV light and hardening the resin in a stable state in which a centrifugal force caused to the rotation of the resin, surface tension and so on are equilibrated; and cutting and removing a thickness unstable portion. In this method, since the UV light is irradiated from a spin coater, an UV curable resin remaining at the spin coater is hardened when spin coating, making it difficult to remove the remaining resin. Also, since this method requires the operation of cutting the thickness unstable portion, the productivity is degraded.

Accordingly, there is a demand for a method of preventing the occurrence of a ski-jump when the coating solution is spin-coated on the substrate.

### SUMMARY OF THE INVENTION

The present invention provides a spin coating apparatus which can prevent an occurrence of a ski-jump.

Also, the present invention provides a coated substrate manufactured by the spin coating apparatus.

According to an aspect of the present invention, there is provided a spin coating apparatus comprising a ring-shaped or polygonal member, wherein an upper portion of the ring-shaped or polygonal member has an inclined portion extending downward and outward, and an inner portion of the inclined portion is adjacent to or in contact with an outer edge of a substrate.

According to specific embodiments of the present invention, an inner surface of the ring-shaped or polygonal member may be inclined downward and outward. The spin coating apparatus may further comprise a supporter for supporting the substrate such that a portion of the surface opposite to a surface to be spin-coated is exposed. An area of a contact surface in which the supporter and the substrate contact each other is 5-95% of the total area of the substrate in an outer radial direction. The spin coating apparatus may have an opening between the ring-shaped or polygonal member and the supporter.

According to another aspect of the present invention, there is provided a substrate manufactured by the spin coating apparatus of one of claims 1 through 5, wherein a thickness deviation of a coating layer at an area not including a ski-jump at an edge of the substrate is within ±2%, and the height of the ski-jump at the edge of the substrate is within ±10% with respect to an average thickness at the edge of the coating layer.

The coated substrate may be an optical disc having a thickness deviation of a data recording region from a center to a radius of 58.5 mm may be less than 2%, and the thickness deviation of the ski-jump may be less than 10%.

### BRIEF DESCRIPTION OF THE DRAWINGS

The above and other features and advantages of the present invention will become more apparent by describing in detail exemplary embodiments thereof with reference to the attached drawings in which:

FIG. 1 is a side view illustrating a ski-jump phenomenon occurring at edge of a substrate when the substrate is spin-coated in a conventional method;

FIG. 2 is a side view of a substrate housing in a conventional apparatus for spin-coating an optical disc;

FIG. 3 is a sectional view of a semiconductor substrate;

FIG. 4 is a view of a spin coating apparatus according to an embodiment of the present invention;

FIG. 5 is a view of ring-shaped or polygonal members according to embodiments of the present invention;

FIG. 6 is a view of openings formed between ring-shaped or polygonal members and supporters according to embodiments of the present invention;

FIG. 7 is a view of supporters according to embodiments of the present invention; and

FIG. 8 is a view illustrating the movement of a substrate spin-coated by the spin coating apparatus according to an embodiment of the present invention.

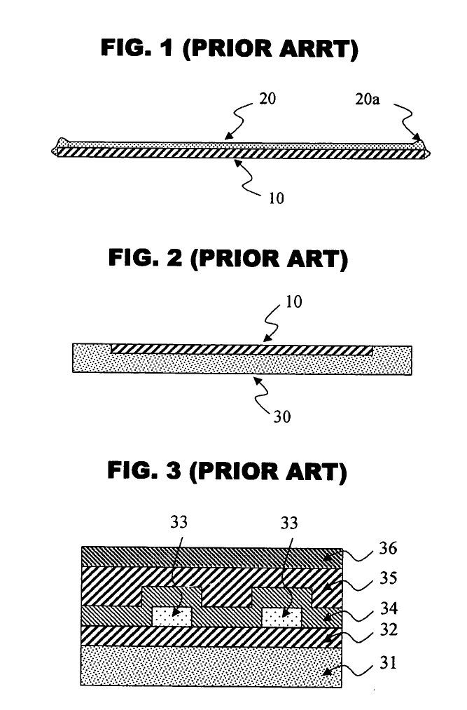

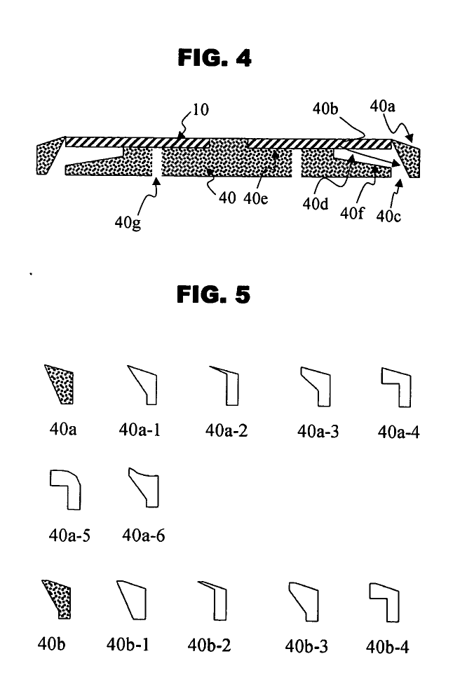

### DETAILED DESCRIPTION OF THE INVENTION

The present invention will now be described more fully with reference to the accompanying drawings.

FIG. 4 is a view of a spin coating apparatus according to an embodiment of the present invention.

Referring to FIG. 4, the spin coating apparatus includes a ring-shaped or polygonal member having an inclined portion that extends downward and outward. When mounting a substrate 10 on the spin coating apparatus, an inner side is adjacent to or in contact with an outer edge of the substrate.

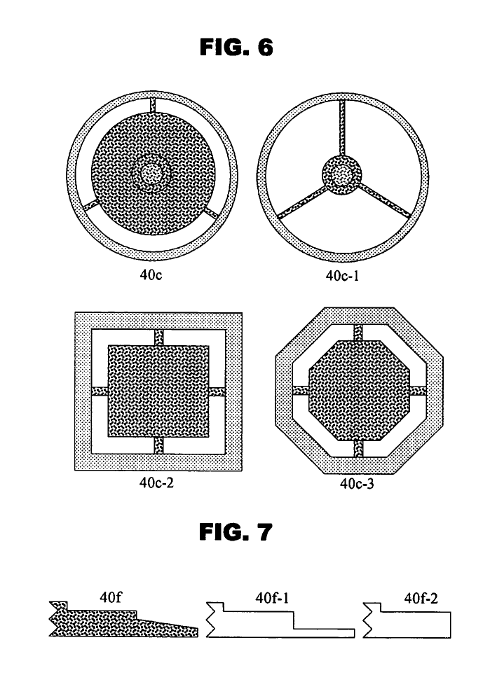

When the upper surface 40a of the ring-shaped or polygonal member is planar, a ski-jump occurs on the coated substrate 10 spin-coated by this apparatus. However, when the upper surface 40a of the ring-shaped or polygonal member is inclined, no ski-jump or a very small ski-jump occurs. The inclined portion of the ring-shaped or polygonal member may be formed from a portion contacting with the inner side or from a central portion of the upper surface (refer to FIG. 5). However, when the inclined portion is formed from the portion contacting the inner side, abrasion or damage may occur when installing or separating the substrate 10. Therefore, it is preferable that the inclined portion is formed 0.1-2 mm from the contact portion. There is no limit to the degree of inclination of the inclined portion of the ring-shaped or polygonal member. For example, the inclined portion may be curved. FIG. 5 is a view illustrating the upper surfaces 40a of the ring-shaped or polygonal member according to embodiments of the present invention. However, the present invention is not limited to the upper surfaces illustrated in FIG. 5.

The size of the inner portion of the ring-shaped or polygonal member can be set to maintain a large enough interval between the ring-shaped or polygonal member and the substrate 10 to smoothly install or separate the substrate while contacting with the end portion of the substrate 10. A height of the inner portion of the ring-shaped or polygonal member is approximately equal that of the mounted substrate 10. The height may be determined by the user according to the thickness of the substrate 10 to be coated. For example, when the thickness of the substrate 10 to be coated is 1.1 mm, a difference between the height of the inner portion of the ring-shaped or polygonal member and the height of the substrate 10 is within ±0.6 mm.

The inner surface 40b of the ring-shaped or polygonal member can have an inclined portion extending downward and outward. The inclined portion can prevent contamination of the substrate 10 by preventing the flow of the coating solution between the outer edge of the substrate 10 and the inner surface of the ring-shaped or polygonal member, and can make it easy to install and separate the substrate 10 from the apparatus according to an embodiment of the present invention. The inclined portion of the inner surface 40b of the ring-shaped or polygonal member may be formed from a portion contacting the upper surface 40a of the ring-shaped or polygonal member or may be formed from the middle of the inner surface 40b. The inner surface 40b of the ring-shaped or polygonal member can have various shapes as shown in FIG. 5, but the present invention is not limited to thereto.

Referring to FIG. 4, the spin coating apparatus according to an embodiment of the present invention can further include a supporter 40 for mounting the substrate 10. An empty space 40d may be formed between the substrate 10 and the supporter 40 to expose a rear surface (of the substrate) opposite to the surface to be coated. The space 40d can prevent the rear surface of the substrate from being contaminated due to the coating solution flowing into a gap between the outer edge of the substrate 10 and the inner surface 40b of the ring-shaped or polygonal member when spin-coating the substrate 10. The supporter 40 is not limited to the above described shaped, and can have any shape that can support the substrate 10 such that a portion of the rear surface of the substrate 10 is exposed. Preferably, an inner inclined portion 40f which extends downward and outward is formed below the space 40d in order to smoothly discharge the coating solution. Various shapes that the supporter can take are shown in FIG. 7, but the present invention is not limited to thereto.

The supporter 40 may include a vacuum hole 40g for fixing the substrate 10 using a vacuum when mounting the substrate 10. The vacuum hole 40g can be located at any position in the supporter 40 below the substrate 10.

A width of an upper contact surface 40e of the supporter 40 is not limited, as long as the space 40d can be formed. An area of the contact surface in which the supporter 40 and the substrate 10 contact each other can be 5-95% of a total area of the substrate 10 in an outer radial direction from the center. When the substrate 10 is manufactured using a die or by cutting, a fine tilt may occur in the substrate 10 itself. If such a substrate 10 having a tilt is mounted on the spin coating apparatus according to an embodiment of the present invention, it is difficult to adjust the height of the substrate 10 and the height of the inner edge of the upper surface 40b of the ring-shaped or polygonal member. In this case, if the contact surface 40e is sufficiently widened, the tilt of the substrate 10 can be compensated for by applying a pressure through the vacuum hole 40g such that the height of the substrate 10 and the height of the inner edge of the upper surface 40b of the substrate can be adjusted. If the area of the contact surface 40e exceeds 95% of the total area of the substrate 10, a rear surface of the substrate 10 may be contaminated due to the coating solution during the spin coating.

The spin coating apparatus according to an embodiment of the present invention can further include an opening 40c between the ring-shaped or polygonal member and the supporter. The opening 40c discharges the coating solution flowing into the gap between the periphery of the substrate 10 and the inner surface 40b of the ring-shaped or polygonal member during the spin coating, thereby preventing the substrate 10 or apparatus from being contaminated due to the remaining coating solution. The size or location of the opening can be adjusted. Although shapes of the opening 40c are shown in FIG. 6, the present invention is not limited thereto. The ring-shaped or polygonal member and the supporter 40 can be formed of stainless steel, aluminum or their alloys, but the present invention is not limited thereto.

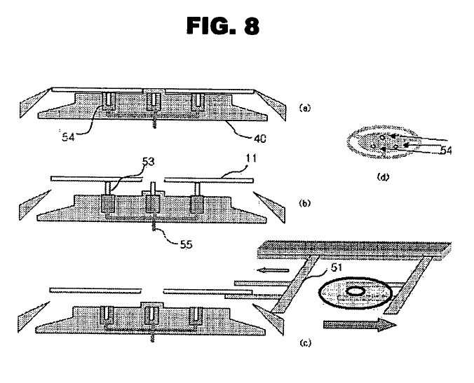

FIG. 8 is a view illustrating the movement of the spin-coated substrate 11 when the spin coating is performed using the spin coating according to an embodiment apparatus of the present invention. Referring to FIG. 8, after the spin coating, a substrate holder 53 connected to an air cylinder 54 placed inside the supporter 40 is lifted up to separate the coated substrate 11 from the supporter 40. Then, a substrate transferring unit 51 is moved below the coated substrate 11. When the coated substrate 11 is positioned on the substrate transferring unit 51, it is moved in parallel below an UV curing unit 52(not shown). Then, the coated substrate 11 is hardened by irradiated ultraviolet rays. FIG. 8(d) is a planar perspective view of the spin coating apparatus.

The spin coating apparatus according to an embodiment of the present invention can be used to manufacture a write once read many (WORM) optical disc, an erasable optical disc, and a read only memory (ROM) optical disc. Also, the spin coating apparatus according to an embodiment of the present invention can be used in an optical disc having a cover layer and a spacer layer, which are formed by the spin coating. Further, the present invention can be applied to manufacturing of semiconductors and the manufacturing of an acoustic matching layer for an ultrasonic transducer. The present invention is not limited to these applications, and can be applied to any fields in which ski-jump problem occurs.

The following examples 1 through 6 and comparative examples 1 and 2 illustrate results when spin coating apparatuses according to embodiments of the present invention and the conventional art applied to the coating of optical discs.

### EXAMPLE 1

Referring to FIG. 4, the height of the inner portion of the upper surface 40b of the ring-shaped member was equal to that of the substrate, and the upper surface 40b of the ring-shaped member was inclined outwards with an angle of 15° and the inner surface Of the ring-shaped member was inclined outwards with an angle of 45°. The diameter of a surface of the supporter contacting the substrate 10 was 80 mm. The ring-shaped member and the supporter were formed of aluminum. A polycarbonate (PC) having a total thickness of 1.1 mm, an outer diameter of 120 mm and an inner diameter (diameter of a central hole) of 15 mm was injection molded. Then, the substrate 10 was manufactured by forming a four-layer structure of Ag alloy/ZnS—SiO₂/SbGeTe/ZnS—SiO₂ with a sputtering process. Then, a cover layer with a thickness of 100 μm was formed by spin coating EB 8402 (made by SK UCB) and Irgacure 184 (made by Ciba SC), 651 (made by Ciba SC), and UV curable resin having methylethylketone using the spin coating apparatus. The coated substrate 11 was manufactured by irradiating the UV light source to cure a photo-curable resin. Coating thicknesses according to radii of the substrate are shown in Table 1 below.

### EXAMPLE 2

The substrate of the present example was manufactured in the same manner as in example 1, except that the cover layer was 75 μm thick. Coating thicknesses according to radii of the substrate are shown in Table 1 below.

### EXAMPLE 3

The substrate of the present example was manufactured in the same manner as in example 1, except that the cover layer was 50 μm thick. Coating thicknesses according to radii of the substrate are shown in Table 1 below.

### EXAMPLE 4

The substrate of the present example was manufactured in the same meaner as the example 1, except that the cover layer was 25 μm thick. Coating thicknesses according to radii of the substrate are shown in Table 1 below.

TABLE 1

| | DISTANCE FROM CENTER OF SUBSTRATE (mm) | | | | | | |
|---|---|---|---|---|---|---|---|
| | | | | | | | Ski-jump |
| | | | | | | | at |
| | 21 | 30 | 40 | 50 | 55 | 58.5 | periphery |
| Example 1 | 100.5 μm | 100.0 μm | 100.5 μm | 100.5 μm | 101.0 μm | 101.0 μm | 103.0 μm |
| Example 2 | 75.5 μm | 75.0 μm | 75.0 μm | 75.5 μm | 75.5 μm | 76.0 μm | 77.5 μm |
| Example 3 | 50.0 μm | 49.5 μm | 49.5 μm | 50.0 μm | 51.0 μm | 51.0 μm | 51.5 μm |
| Example 4 | 25.5 μm | 25.0 μm | 26.0 μm | 26.0 μm | 25.5 μm | 26.0 μm | 26.0 μm |

As can be seen in Table 1, when the substrate is spin-coated to a thickness of 100 μm, the ski-jump is within 3 μm. When the substrate is spin-coated to less than 100 μm, the ski-jump does not occur or has a very low height. Also, there is no contamination of the substrate due to the resin during the spin coating.

### EXAMPLE 5

The substrate of the present example was manufactured in the same manner as in example 1, except that the height of the inner portion of the upper surface of the ring-shaped member was 0.2 mm greater than the substrate. Coating thicknesses according to radii of the substrate are shown in Table 2 below.

### EXAMPLE 6

The substrate of the present example was manufactured in the same manner as in example 1, except that the height of the inner portion of the upper surface of the ring-shaped member was 0.2 mm lower than the substrate. Coating thicknesses according to radii of the substrate are shown in Table 2 below.

TABLE 2

| | DISTANCE FROM CENTER OF SUBSTRATE (mm) | | | | | | |
|---|---|---|---|---|---|---|---|
| | | | | | | | Ski-jump |
| | | | | | | | at |
| | 21 | 30 | 40 | 50 | 55 | 58.5 | periphery |
| Example 5 | 101.0 μm | 101.0 μm | 100.5 μm | 101.5 μm | 101.5 μm | 102.5 μm | 104.5 μm |
| Example 6 | 100.5 μm | 100.5 μm | 101.0 μm | 102.0 μm | 101.5 μm | 102.0 μm | 104.0 μm |

As can be seen in Table 2, when the height of the inner portion of the upper surface of the ring-shaped member was slightly greater than or less than the height of the substrate, the ski-jump occurring at the edge of the substrate was reduced.

### COMPARATIVE EXAMPLE 1

The substrate was manufactured in the same manner as in example 1, except that a spin coating apparatus having no ring-shaped member was used. Coating thicknesses according to radii of the substrate are shown in Table 3 below.

### COMPARATIVE EXAMPLE 2

The substrate was manufactured in the same manner as in example 1, except that there was no inclination in the upper portion of the ring-shaped member. Coating thicknesses according to radii of the substrate are shown in Table 3 below. In this case, the ski-jump at the periphery of the optical disc was 20 μm rather than an average coating thickness. Also, the rear side of the optical disc was seriously contaminated.

TABLE 3

| | DISTANCE FROM CENTER OF SUBSTRATE (mm) | | | | | | |
|---|---|---|---|---|---|---|---|
| | | | | | | | Ski-jump |
| | | | | | | | at |
| | 21 | 30 | 40 | 50 | 55 | 58.5 | periphery |
| Comparative | 101.5 μm | 99.5 μm | 101.0 μm | 103.5 μm | 115.0 μm | 138.5 μm | 147.0 μm |
| Example 1 | | | | | | | |
| Comparative | 100.5 μm | 101.5 μm | 101.0 μm | 102.0 μm | 102.5 μm | 107.5 μm | 118.5 μm |
| Example 2 | | | | | | | |

Examples 7 and 8 and comparative example 3 illustrate results when the spin coating apparatuses according to embodiments of the present invention were applied to semiconductor wafers.

### EXAMPLE 7

An inner diameter of the upper surface of the ring-shaped member was matched with a semiconductor wafer having a diameter of 8 inch, and an inner portion of the upper surface of the ring-shaped member had the same height as the semiconductor wafer. The upper surface of the ring-shaped member was inclined outward with an angle of 15° from the horizontal. An inner surface portion of the ring-shaped member was inclined outward from the center at an angle of 45° to the horizontal. The spin coating apparatus was made of aluminium. First, the wafers on which a thick photoresist layer has to be formed, was cleaned by rotating it at 3000 rpm for 3 seconds. Then, a positive type photoresist was coated on the central portion of the upper surface of the semiconductor wafer and the semiconductor wafer was rotated at a high speed, thereby obtaining a photoresist layer with a thickness of 60 μm thick. Coating thickness according to radii of the semiconductor wafer are shown in Table 4 below.

### EXAMPLE 8

The substrate according to the present example was manufactured in the same manner as in example 7, except that the cover layer was 30 μm thick. Coating thicknesses according to radii of the semiconductor wafer are shown in Table 4 below.

### EXAMPLE 9

The substrate according to the example was manufactured in the same manner as in example 7, except that the spin coating apparatus had no ring-shaped member. Coating thicknesses according to radii of the semiconductor wafer are shown in Table 4 below.

TABLE 4

| | DISTANCE FROM CENTER OF SUBSTRATE (inch) | | | | | | | | |
|---|---|---|---|---|---|---|---|---|---|
| | | | | | | | | | Ski-jump |
| | | | | | | | | | at |
| | 0 | 1 | 2 | 3 | 4 | 5 | 6 | 7 | periphery |
| Example 7 | 60.3 μm | 60.5 μm | 60.1 μm | 60.0 μm | 60.3 μm | 60.1 μm | 60.4 μm | 60.3 μm | 60.9 μm |
| Example 8 | 30.0 μm | 30.3 μm | 30.2 μm | 30.1 μm | 29.9 μm | 30.0 μm | 30.2 μm | 30.1 μm | 30.3 μm |
| Comparative | 60.0 μm | 60.2 μm | 59.8 μm | 60.4 μm | 60.3 μm | 60.4 μm | 60.5 μm | 61.3 μm | 115.4 μm |
| Example 3 | | | | | | | | | |

Examples 10 through 12 and comparative example illustrate results when the spin coating apparatuses according to embodiments of the present invention and the conventional art were applied to an ultrasonic endoscopic piezoelectric ceramic plate.

### EXAMPLE 10

Referring to 40c-2 of FIG. 6, an inner portion of the upper surface of the rectangular member was in contact with four sides of the rectangular member, and the inner portion of the rectangular member had the same height as the substrate. The upper surface of the rectangular member was inclined outward at an angle of 15° to the horizontal. An inner surface of the rectangular member was inclined outward at an angle of 45° to the horizontal. The spin coating apparatus is made of aluminium. The rectangular piezoelectric ceramic plate was mounted on the spin coating apparatus and fixed in vacuum. Then, an epoxy resin, a phenol resin, and an UV curable resin including inorganic particles for impedance control, methylethylketone, toluene and UV curable material were dropped on the central portion of the piezoelectric ceramic plate. Then, the piezoelectric ceramic plate was rotated at a high speed to obtain an acoustic matching layer with a thickness of 30 μm. An average thickness of the acoustic matching layer coated on the piezoelectric ceramic plate and the ski-jump are shown in Table 5 below.

### EXAMPLE 11

An ultrasonic endoscopic piezoelectric ceramic plate was manufactured in the same manner as in example 10, except that the acoustic matching layer was 40 μm thick. An average thickness of the acoustic matching layer coated on the piezoelectric ceramic plate and the ski-jump are shown in Table 5 below.

### EXAMPLE 12

An ultrasonic endoscopic piezoelectric ceramic plate was manufactured in the same manner as in example 10, except that the acoustic matching layer was 50 μm thick. An average thickness of the acoustic matching layer coated on the piezoelectric ceramic plate and the ski-jump are shown in Table 5 below.

### COMPARATIVE EXAMPLE 4

An ultrasonic endoscopic piezoelectric ceramic plate was manufactured in the same manner as in example 12, except the spin coating apparatus had no rectangular member. An average thickness of the acoustic matching layer coated on the piezoelectric ceramic plate and the ski-jump are shown in Table 5 below. In this case, the ski-jump at the outer edge of the piezoelectric ceramic plate is about double the average coating thickness. Also, the thickness of the portion near the ski-jump was increased.

TABLE 5

| | AVERAGE | STANDARD | SKI-JUMP AT END |
|---|---|---|---|
| | THICKNESS | DEVIATION | PORTION |
| Example 10 | 30.1 μm | ±0.1 μm | 30.2 μm |
| Example 11 | 40.3 μm | ±0.3 μm | 40.5 μm |
| Example 12 | 50.4 μm | ±0.5 μm | 51.1 μm |
| Comparative | 52.3 μm | ±2.1 μm | 98.7 μm |
| Example 4 | | | |

The spin coating apparatus according to the present invention can uniformly coat a substrate with a coating solution by removing or reducing a ski-jump phenomenon occurring at an outer edge of the substrate during spin coating. Also, contamination of the substrate due to the coating solution can be remarkably reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A spin coating apparatus comprising a ring-shaped or polygonal member, wherein an upper portion of the ring-shaped or polygonal member has an inclined portion extending downward and outward, and an inner portion of the inclined portion is adjacent to or in contact with an outer edge of a substrate.

2. The spin coating apparatus of claim 1, wherein an inner surface of the ring-shaped or polygonal member is inclined downward and outward.

3. The spin coating apparatus of claim 1, further comprising a supporter for supporting the substrate such that a portion of the surface opposite to a surface to be spin-coated is exposed.

4. The spin coating apparatus of claim 1, wherein an area of a contact surface in which the supporter and the substrate contact each other is 5-95% of the total area of the substrate in an outer radial direction.

5. The spin coating apparatus of claim 3 having an opening between the ring-shaped or polygonal member and the supporter.

6. A coated substrate manufactured by the spin coating apparatus of one of claims 1 through 5, wherein a thickness deviation of a coating layer at an area not including a ski-jump at an edge of the coated substrate is within ±2%, and the height of the ski-jump at the edge of the coated substrate is within ±10% with respect to an average thickness at the edge of the coating layer.

7. The coated substrate of claim 6, wherein the coated substrate is an optical disc having a thickness deviation of a data recording region from a center to a radius of 58.5 mm is less than 2%, and the thickness deviation of the ski-jump is less than 10%.

8. The coated substrate of claim 6, wherein the coated substrate is a semiconductor wafer.

9. The coated substrate of claim 6, wherein the coated substrate is an ultrasonic endoscopic piezoelectric ceramic plate.
